(19) United States
(12) Patent Application Publication
(10) Pub. No.: US 2003/0156367 A1
(43) Pub. Date: Aug. 21, 2003

(54) Arc fault circuit interrupter with upstream impedance detector

(76) Inventor: Bruce F. Macbeth, Syracuse, NY (US)

Correspondence Address: Daniel P. Malley, WALL MARJAMA & BILINSKI LLP, 4th Floor, 101 S. Salina St., Syracuse, NY, 13202, US

(21) Appl. No.: 10/354,661

(22) Filed: Jan. 30, 2003

Related U.S. Application Data
(60) Provisional application No. 60/353,343, filed on Feb. 1, 2002.

(51) Int. Cl. H02H 7/04

(52) U.S. Cl. 361/38

(57) ABSTRACT

An electrical protection device which protects an electrical power distribution system supplying voltage from a secondary winding of a transformer through an electrically conductive path to the protection device includes an impedance detector which measures the impedance of the path. When the impedance of the path exceeds a pre-determined threshold, the protection device produces a signal which is used to indicate a problem or interrupt the circuit. In a system approach, an overcurrent protection device is installed at an origin of a branch circuit for interrupting current when an overcurrent condition is present, while a fault protection device is installed at an outlet in the branch circuit. The fault protection device includes circuitry for measuring an impedance in the branch circuit and circuitry for producing a signal when the measured impedance exceeds a predetermined value. Such a system affords series fault and parallel arc fault protection to the branch circuit.

### CROSS-REFERENCE TO RELATED APPLICATIONS

This application claims priority from U.S. Provisional Application Ser. No. 60/353,343 filed Feb. 01, 2002 and entitled ARC FAULT CIRCUIT INTERRUPTER WITH UPSTREAM IMPEDANCE DETECTOR, incorporated herein by reference.

### FIELD OF THE INVENTION

This invention relates generally to the field of arc fault circuit interrupters, and more particularly to an arc fault circuit interrupter which detects upstream impedance.

### BACKGROUND OF THE INVENTION

A branch circuit of an electrical power distribution system for powering loads is required by code to be protected at its origin by an overcurrent protection device such as a circuit breaker. The branch circuit consists of fixed wires that may be located in a wall cavity and supply cords or extension cords that connect the load to the fixed wiring, and intermediate terminations associated with junction boxes, receptacles, plugs, switches and the like. The function of the overcurrent protection device is to protect the branch circuit from the effects of excessive electrical current. It has been established that while such overcurrent protection devices may be effective in detecting excessive electrical current due to a bolted fault, they may not be as effective in detecting electrical currents associated with arcing fault currents which tend to be intermittent or to sputter in nature, or, even in having detected such arcing fault currents, to open in time before there is risk that the intense heat generated by the arcing fault ignites nearby combustibles. The overcurrent protection device has an inverse interruption time versus current characteristic. Given this characteristic, the ability to safely interrupt an arcing fault requires a sufficiently high current to achieve a sufficiently short interrupting time. The secondary winding of a transformer, preferably having substantially negligible impedance, provides supply voltage to the electrical distribution system. As the loop impedance from the supply voltage to the arcing fault location increases, including resistances associated with the electrical conductors and conductor terminations, the loop current passing through the arcing fault location and the overcurrent protection device decreases, causing the interrupting time of the overcurrent protection device to increase. Thus the loop impedance tends to negate the ability of the overcurrent protection device to interrupt the arcing fault. Considering the variety of overcurrent protection devices, including fuses and circuit breakers, a worst case impedance can be determined which if exceeded would not allow the overcurrent protection device to afford arc fault protection.

Arc fault circuit interrupters (AFCI's) as defined in Underwriters Laboratories standard 1699 establish a new class of protection device that is specifically designed to detect and interrupt the sputtering currents associated with arcing faults. Among the embodiments of arc fault circuit interrupters is a circuit breaker-type AFCI which is a combination overcurrent protection device with a feature for detecting the characteristics of an arcing fault current. Circuit breaker-type AFCI's are able to interrupt the arcing fault by de-energizing the branch circuit. Another embodiment is the outlet type AFCI, with or without integral receptacles, which is intended to be installed in a wall box which is the first outlet of the branch circuit. An outlet type AFCI is equipped with line terminals for electrical connection to an overcurrent protection device and load terminals for connection to the remaining portion of the branch circuit, sometimes termed “downstream” of the AFCI. The outlet-type AFCI interrupts an arcing fault by de-energizing the downstream circuit. However, for a protective system consisting of an overcurrent protection device, e.g., a circuit breaker, and an outlet-type AFCI installed at the first outlet, the branch circuit portion between these two devices, known as the “home-run”, may not be arc-fault protected. This would occur if the negating impedance to the arc fault in the home-run prevents the overcurrent protection device from operating, while the outlet-type AFCI is only able to protect and de-energize the portion of the branch circuit downstream from the outlet-type AFCI, thus permitting the arc current in the home-run to continue flowing.

### SUMMARY OF THE INVENTION

An aspect of this invention is to assure that a protective system consisting of a traditional overcurrent device and an outlet-type AFCI affords arc fault protection to the home-run. Another aspect is to alert the installer if home-run protection is not afforded, for example, by providing the outlet-type AFCI with an indicator or an automatic trip-out feature that identifies when such protection is not afforded. Another aspect of the invention is to provide an outlet-type AFCI with a negating impedance test capability that ascertains if the conventional circuit breaker is able to afford protection, and to alert the user if the negating impedance is of such magnitude to prevent protection. Another aspect of the invention is to alert the user by way of an indicator or an automatic trip-out feature to an abnormal impedance in a branch circuit, or portion thereof. Another aspect of the invention is to alert the user by way of an indicator or an automatic trip-out feature to an abnormal impedance in the entire branch circuit by locating an outlet-type AFCI at the last outlet of the branch circuit.

Briefly stated, an electrical protection device which protects an electrical power distribution system supplying voltage from a secondary winding of a transformer through an electrically conductive path to the protection device includes an impedance detector which measures the impedance of the path. When the impedance of the path exceeds a pre-determined threshold, the protection device produces a signal which is used to indicate a problem or interrupt the circuit. In a system approach, an overcurrent protection device is installed at an origin of a branch circuit for interrupting current when an overcurrent condition is present, while a fault protection device is installed at an outlet in the branch circuit. The fault protection device includes circuitry for measuring an impedance in the branch circuit and circuitry for producing a signal when the measured impedance exceeds a predetermined value. Such a system affords series fault and parallel arc fault protection to the branch circuit.

According to an embodiment of the invention, an electrical protection device, protective of an electrical power distribution system supplying voltage from a secondary winding of a transformer through an electrically conductive path to the protection device, includes a plurality of line terminals which receive voltage from the electrically conductive path; and an impedance detector for measuring an impedance of the path; wherein when the impedance detected by the impedance detector exceeds a pre-determined threshold, the protection device produces a signal.

According to an embodiment of the invention, a system of protective devices for protecting an electrical branch circuit includes an overcurrent protection device installed at an origin of the branch circuit for interrupting current when an overcurrent condition is present; a fault protection device installed at an outlet in the branch circuit; wherein the fault protection device includes means for measuring an impedance in at least a portion of the branch circuit and means for producing a signal when the measured impedance exceeds a predetermined value; wherein the system of protective devices affords series fault and parallel arc fault protection to at least a portion of the electrical branch circuit.

According to an embodiment of the invention, an ohmmeter device incorporated in an electrical protector of an electrical power distribution system for monitoring an unknown impedance includes a voltage source which induces a test current signal through the unknown impedance, thereby causing a voltage drop signal; and a comparator which determines if the voltage drop signal across the unknown impedance exceeds a predetermined threshold, whereupon the comparator sends a signal to the electrical protector.

According to an embodiment of the invention, in an electrical protection device, protective of an electrical power distribution system supplying voltage from a secondary winding of a transformer through an electrically conductive path to the protection device, wherein the device includes a plurality of line terminals which receive voltage from the electrically conductive path, a plurality of load terminals for delivering voltage from the secondary winding of the transformer to a load, and a plurality of interrupting contacts between the load terminals and the line terminals; a method for protecting the electrical power distribution system includes the steps of: measuring an impedance of the path; and producing a signal when the measured impedance exceeds a pre-determined threshold; wherein the signal causes the interrupting contacts to disconnect the load terminals from the line terminals.

According to an embodiment of the invention, in an electrical protection device, protective of an electrical power distribution system supplying voltage from a secondary winding of a transformer through an electrically conductive path to the protection device, wherein the device includes a plurality of line terminals which receive voltage from the electrically conductive path, and a plurality of load terminals for delivering voltage from the secondary winding of the transformer to a load; a method for protecting the electrical power distribution system includes the steps of generating a voltage signal to produce a test current in at least a portion of the electrical power distribution system; measuring a signal responsive to the voltage signal; and comparing the measured signal against a pre-determined reference signal to determine a fault condition within the portion of the electrical power distribution system.

### BRIEF DESCRIPTION OF THE DRAWINGS

FIGS. 1A and 1B are schematics for related art ohmmeters;

FIG. 2 shows a schematic for an outlet-type AFCI according to an embodiment of the invention;

FIG. 3A shows a portion of a schematic of a variation of the embodiment of FIG. 2;

FIG. 3B shows a portion of a schematic of a variation of the embodiment of FIG. 2;

FIG. 3C shows a portion of a schematic of a variation of the embodiment of FIG. 2;

FIG. 4 shows a schematic for an outlet-type AFCI according to an embodiment of the invention;

FIG. 5 shows a schematic for a combination AFCI/GFCI according to an embodiment of the invention;

FIG. 6A shows a schematic for an outlet-type AFCI according to an embodiment of the invention;

FIG. 6B shows a portion of a schematic of a variation of the embodiment of FIG. 6A;

FIG. 7A shows a schematic for an AFCI according to an embodiment of the invention;

FIG. 7B shows a waveform used in explaining the operation of the embodiment of FIG. 7A; and

FIG. 8 shows a schematic for an AFCI according to an embodiment of the invention.

### DETAILED DESCRIPTION OF THE PREFERRED EMBODIMENT

One class of arc faults is known as a B-type, or parallel arc fault. In a B-type arc fault, the arc occurs across two conductors in the branch circuit at a site where the insulating media separating the two conductors has been compromised. The arc may occur across the line and neutral conductors or the line and ground conductors, or in the case of reverse polarity where the line and neutral conductors are connected to the overcurrent protective device in reverse, the arc may occur across the neutral and ground conductors. The current through the B-type fault is not limited by the impedance of the load but by the available current from the supply voltage and the conductors and terminals to the parallel arc fault, i.e., the loop impedance previously described as a negating impedance.

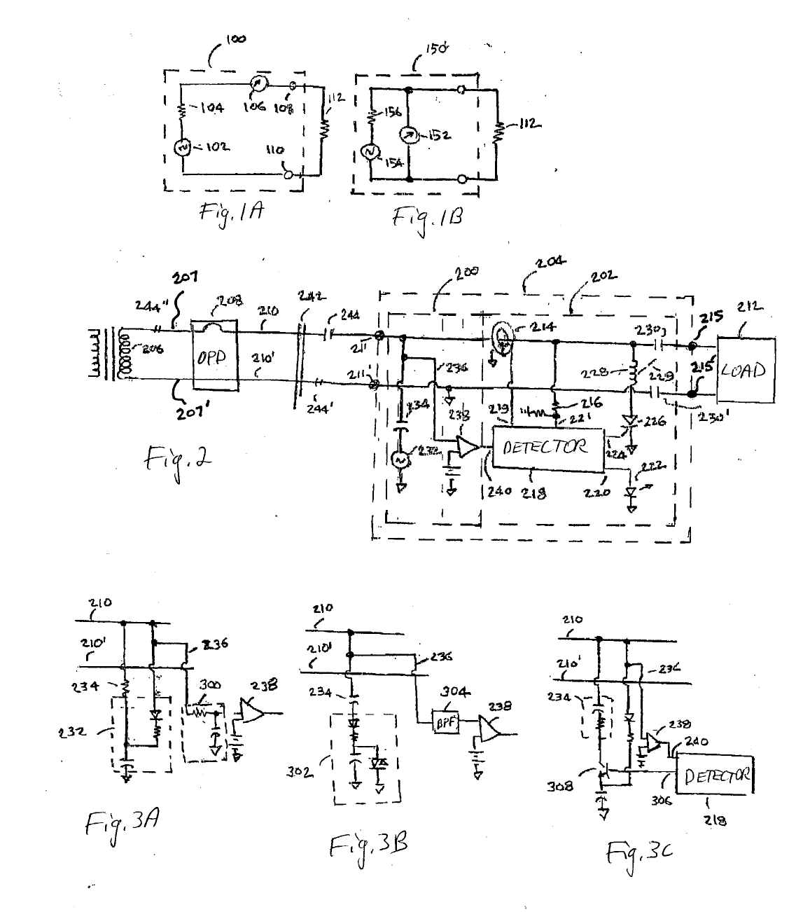

Referring to FIG. 1A, an ohmmeter 100 is shown. Ohmmeter 100 includes a voltage source 102, an impedance 104, and a meter 106 in series. When terminals 108 and 110 are connected to an unknown impedance 112, the meter responds to the loop current. Referring to FIG. 1B, an ohmmeter 150 includes a meter 152 in parallel with the voltage source 154 in series with impedance 156. In FIG. 1A, the meter reading is insensitive to unknown impedances that are much greater than impedance 104, whereas in FIG. 1B, the meter reading is insensitive to unknown impedances that are much smaller than impedance 156.

Referring to FIG. 2, device 204 of the present invention includes ohmmeter 200 and AFCI 202. Device 204 is preferably installed in an outlet box located in the branch circuit. A portion of an electrical power distribution system includes a secondary winding of a transformer for supplying voltage 206 connected to an overcurrent protection device (OPD) 208 located at the origin of a particular branch circuit, a home-run length of conductor 210 and 210′ connected to the line side terminals of 211 and 211′ of device 204, and a load 212 connected to load terminals 215 and 215′ of device 204. The load terminals includes receptacle terminals (not shown) that may be integral with device 204 or feed-through terminals. Those of ordinary skill in the art will understand that feed through terminals are employed to subdivide load 212. AFCI 202 may include a sensor 214 for monitoring the current through the branch circuit and is optionally equipped with a voltage sensor 216 for monitoring the supply voltage.

Sensors 214 and 216 provide signal to inputs 219 and 221 of detector 218, respectively, which examines the sensed signals for the presence of an arc fault signature, whereupon detector 218 optionally provides an arc detection indication at an output 220 of detector 218, observable on an indicator such as lamp 222, or may be equipped with a circuit interruption capability, including an output 224 of detector 218, an SCR 226, a trip solenoid 228, a mousetrap mechanism 229, and interrupting contacts 230 and 230′. Contacts 230 and 230′ open to disconnect load 212 from the source of electrical power induced in secondary winding 206.

Ohmmeter 200 includes a voltage source 232 and a coupling impedance 234 for imposing an electrical current through the unknown impedance 112 in the manner shown in FIG. 1. The unknown impedance 112 consists of the impedances of the home-run conductors 210 and 210′, the impedances of conductors 207 and 207′ upstream of the overcurrent protection device 208, and the impedances of the associated terminals and conductive members. Ohmmeter 200 has an output terminal 236 which provides signal to a comparator 238. If the unknown impedance 112 exceeds a predetermined value, comparator 238 sends a signal to detector 218 input 240. Since an impedance 112 exceeding a predetermined value is indicative that the overcurrent protection device 208 may not be able to interrupt a parallel arc fault in the home-run, generally shown at 242, detector 218 produces a warning signal at output 220 of detector 218, or alternatively, produces a circuit interruption signal at output 224 of detector 218. In at least one manner, the user is alerted that overcurrent protection device 208 is unprotective of parallel arc faults. In addition, detector 218 could produce a signal that is connected to overcurrent protection device 208 to trip device 208. This connection could be via a separate signal wire, power line communications, or wireless transmitter.

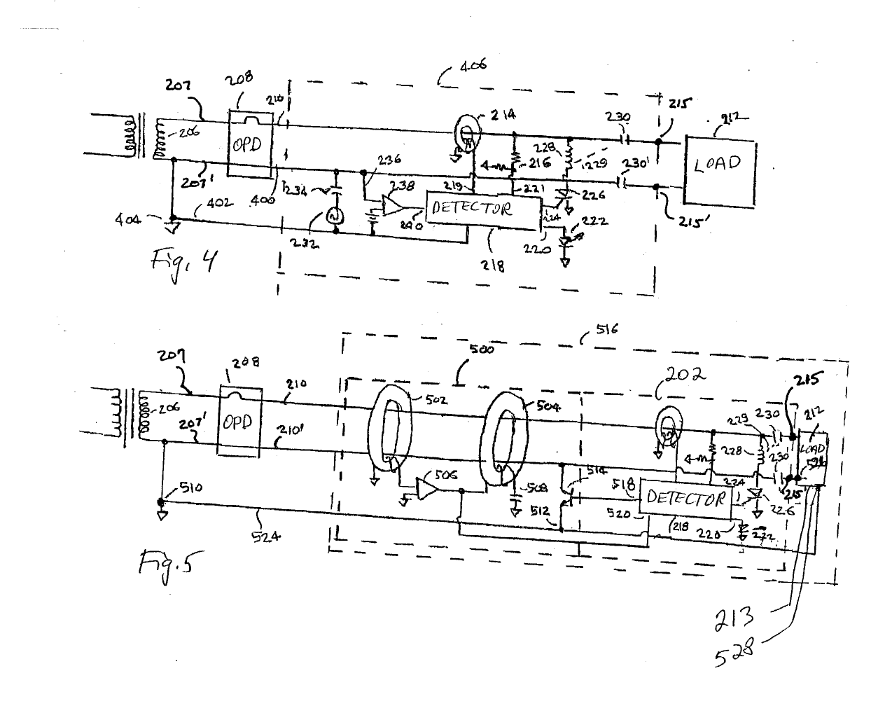

Referring to FIGS. 3A-3B, a portion of FIG. 2 is shown detailing voltage source 232 and impedance 234. Components having the same function as in FIG. 2 bear the same designations. Voltage source 232 can be any number of embodiments, whichever best allows the unknown impedance 112 to be detected in the presence of the AC supply voltage, typically a 50 Hz or 60 Hz sinusoid, and in the presence of high frequency noise that may emanate from the supply voltage or load 212. FIG. 3A shows a DC test method, in which voltage source 232 is a DC voltage derived from the line terminals of device 204, and impedance 234 is a resistor to allow loop current through unknown impedance 112. The output 236 of ohmmeter 200 is connected to a low pass filter 300 for passing only DC signal to comparator 238 that is devoid of line frequency signal or high frequency noise. In FIG. 3B, voltage source 232 can be an AC signal, preferably higher than the line frequency produced by a local oscillator 302. Impedance 234 may be a capacitor or a capacitor in series with a resistor to carry the AC signal. The output 236 of the ohmmeter 200 is connected to a band pass filter 304 tuned to the frequency produced by local oscillator 302 to pass solely that frequency to comparator 238 while rejecting the line frequency and electrical noise. FIG. 3C is the same as FIG. 3B, except the local oscillator has been omitted and detector 218, preferably a microprocessor having a clock, has an output 306 which closes switch 308 to produce a signal composed of repeating pulses at a pre-determined frequency producing a test current through impedance 234 and unknown impedance 112.

Detector 218 embodied as a microprocessor conveniently allows other methods that improve the ability to detect unknown impedance 112 in the presence of supply voltage and electrical noise. For example, output 306 of detector 218 initiates a pulse so that signals that do not occur simultaneously at input 240 of detector 218 may be rejected as noise. Alternatively, detector 218 output 306 may issue a train of pulses so that signals at input 240 of detector 218 that do not bear the same count may be rejected as noise. Voltage sensor 216 can also provide intelligence to detector 218 regarding the positions of the zero crossing of the power line frequency. Input 240 or output 306 of detector 218 may be gated to receive or to initiate a test signal, respectively, proximate the zero crossings. In this manner, the impedance measurement is made when the supply voltage is near or at minimum to enhance the recognition of the impedance test signal. Likewise, a shunt (not shown) can be incorporated in conductors 210 or 210′ to detect zero crossings in load current and impedance measurement can be made when the load current is at or near minimum to enhance the recognition of the impedance test signal.

As yet another alternative, input 240 or output 306 of detector 218 may be gated to receive or to initiate a test signal, respectively, for a predetermined period following appearance of supply voltage at the line terminals of device 204. In this manner the home-run is tested immediately after the installation is complete when it is most critical to do so, while device 204 is immune to electrical noise occurring thereafter. The predetermined period may occur on appearance of line voltage and then may be repeated automatically, such as on a daily or monthly schedule, to assure that the installation continues to be safe, while at the same time, noise immunity is accomplished from the significant durations while ohmmeter 200 is inactive. Detector 218 may also be equipped with digital techniques for filtering electrical noise. To those skilled in the art, there are any number of techniques or combinations of techniques that impart noise immunity to the ohmmeter test function, of which the techniques that have been named should be considered representative.

Referring to FIG. 4, an alternate to device 204 is shown generally as 406 in which the loop impedance involves neutral conductor 400 and ground conductor 402, whereas FIG. 2 has two unspecified conductors that could be the line and neutral conductors or alternatively two line conductors in the case of a split phase or a three phase multi-wire circuit. Components that perform the same function as those in FIG. 2 bear like designations. Voltage source 232, impedance 234, and ohmmeter output 236 have been reconnected to test the unknown impedance associated with neutral conductor 400 and ground conductor 402, with the two conductors bonded at the service entrance at location 404. Device 406 operates in the same manner as device 204 to assure that the loop impedance is sufficiently low to allow the overcurrent protection device 208 to afford parallel arc fault protection to the home-run consisting of conductors 210, 400, and 402. The embodiment in 406 is intended solely for a system having a ground conductor 402, for which device 406 has the advantage of detecting if the ground conductor 402 is absent which would be revealed by high impedance at ohmmeter output 236.

Referring to FIG.5, an alternative to device 204 is generally shown as 516, which has an AFCI 202 and a ground fault circuit interrupter or “GFCI” protective feature 500 that, with minor adaptation, additionally provides the ohmmeter test function 200. GFCI requirements are described in UL standard 943. Components having like function to those in FIG. 2 bear like designations. Differential transformer 502 senses fault currents from line to ground. A neutral transformer 504 enables differential transformer 502 to sense fault currents from neutral to ground, as described in U.S. Pat. No. 3,936,699 incorporated by reference herein. An example of a neutral to ground fault is shown at a location 526 where the neutral conductor 210′ to load 212 has accidentally made electrical contact to a metal frame 213 of load 212. Ground conductor 524 is deliberately connected to metal frame 213 at a location 528. Since the National Electrical Code requires a grounding between neutral conductor 210′ and ground conductor 524 at the service entrance, shown at location 510, the neutral to ground fault completes a low impedance loop consisting of neutral conductor 210′, ground conductor 524, and metal frame 213 which electrically connects location 526 to location 528. Upon establishment of the neutral to ground fault, the ever-present noise from amplifier 506 continues to be connected to neutral transformer 504. Neutral transformer 504 sends a noise current around the loop thus completed, which is sensed by differential transformer 502. The noise signal sensed by differential transformer 502 is amplified by amplifier 506 and sensed by neutral transformer 504. If the loop impedance is below a pre-determined value, conditions are sufficient for regenerative feedback, upon which signal from amplifier 506 to input 520 of detector 218 causes interrupting contacts 230 and 230′ open as previously described.

Alternatively, neutral transformer 504 can receive signal from a local oscillator (not shown) or derive signal from the power line frequency or a portion thereof (not shown.) Irrespective of the origin of the signal, neutral transformer 504, differential transformer 502, and amplifier 506 produce signals such that the presence of the wire loop formed by the neutral to ground fault is detectable.

For the case of a line to ground fault, differential transformer 502 produces a signal which is amplified by amplifier 506. Amplifier 506 sends a signal to input 520 of detector 218. Signal at input 520 exceeding a threshold established by detector 218 causes interrupting contacts 230 and 230′ to open.

The neutral to ground detection feature of a GFCI causes interrupting contacts 230 or 230′ to open if a low loop impedance is detected, as has been described. The neutral to ground detection feature can be adapted to provide the ohmmeter function, in which interrupting contacts 230 or 230′ open or indicator 222 indicates if a high loop impedance is detected. Also, the ohmmeter function can be provided with or without the neutral to ground detection feature of a GFCI.

The ohmmeter function is accomplished by providing detector 218 with an output terminal 518 which enables transistor 514 to turn on and artificially produce a neutral to ground fault. If the loop impedance of conductors 210′, 524, and transistor 514 is sufficiently small, amplifier 506 produces a signal at input 520 of detector 218. Signal at input 520 of detector 218 exceeding a threshold established by detector 218 while transistor 514 is on is interpreted as an acceptable unknown impedance test, so interrupting contacts 230 and 230′ remain closed. If the loop impedance is not sufficiently small while transistor 514 is on, the threshold established by detector 218 is not exceeded. This is interpreted as an unacceptable unknown impedance test, so that interrupting contacts 230 and 230′ open or indicator 222 is activated. Whether by way of interruption or indication, or both, the user is alerted to overcurrent protection device 208 being unable to afford parallel arc fault protection to the home-run consisting of conductors 210, 210′, and 524. The ohmmeter function takes place while transistor 514 is on. The optional neutral to ground feature of GFCI 500 is provided as previously described while transistor 514 is off. As in the case of the embodiment of FIG. 4, the embodiment of FIG. 5 is only intended for an installation having a ground conductor 524.

Another class of arc faults is known as A-type arc faults, i.e., those in which the arcing condition occurs across a discontinuity in the line or neutral conductors. Discontinuities could be caused by a broken conductor or by a loose terminal. A-type arc faults occur when load current conducts intermittently through the discontinuity, or sputters. Since the current through the A-type fault is limited by the impedance of the load itself, because the fault is in series with the load, an A-type fault is also known as a “series fault.”

Referring back to FIG. 2, series arc faults are shown at locations 244, 244′ and 244″. Since the current through series arcs are limited by the load 212 and the series arc fault current is below the interruption rating of the overcurrent protection device 208, the impedance loop cannot be protected from series arcing fault hazards by overcurrent protection device 208. For series arc faults that occur specifically in the home-run and upstream of the overcurrent protection device 208, such as at locations 244, 244′ and 244″, the impedance associated with the discontinuity becomes another component of the unknown impedance 112 (FIGS. 1A-1B), which the present invention can detect. Device 204 may either alert the user to the series arc fault condition through a signal at output 220 of detector 218 or may open interrupting contacts 230 and 230′ to terminate the series arcing current to remove the fire hazard.

As an additional benefit, ohmmeter 200 can detect the added impedance associated with the series arc fault regardless of whether load 212 is on or off so that the potential arcing fault hazard can be detected and interrupted before the arcing condition itself takes place. As a further benefit, it is desirable for the AFCI to afford as much branch circuit protection as possible. Device 204 protects the overcurrent protection device itself and the lateral run from the transformer to the service entrance from series arc faults in which fires of electrical origin have been known to occur. It is also desirable for the outlet AFCI to detect and interrupt upstream arc faults that are uniquely located in the protected branch circuit, that is, the branch circuit associated with load 212. Series arcs faults occurring in unprotected branch circuits do not affect unknown impedance 112, so the risk of an arc fault signature from the unprotected branch circuit providing false signal in the protected branch circuit is totally avoided through the use of ohmmeter 200.

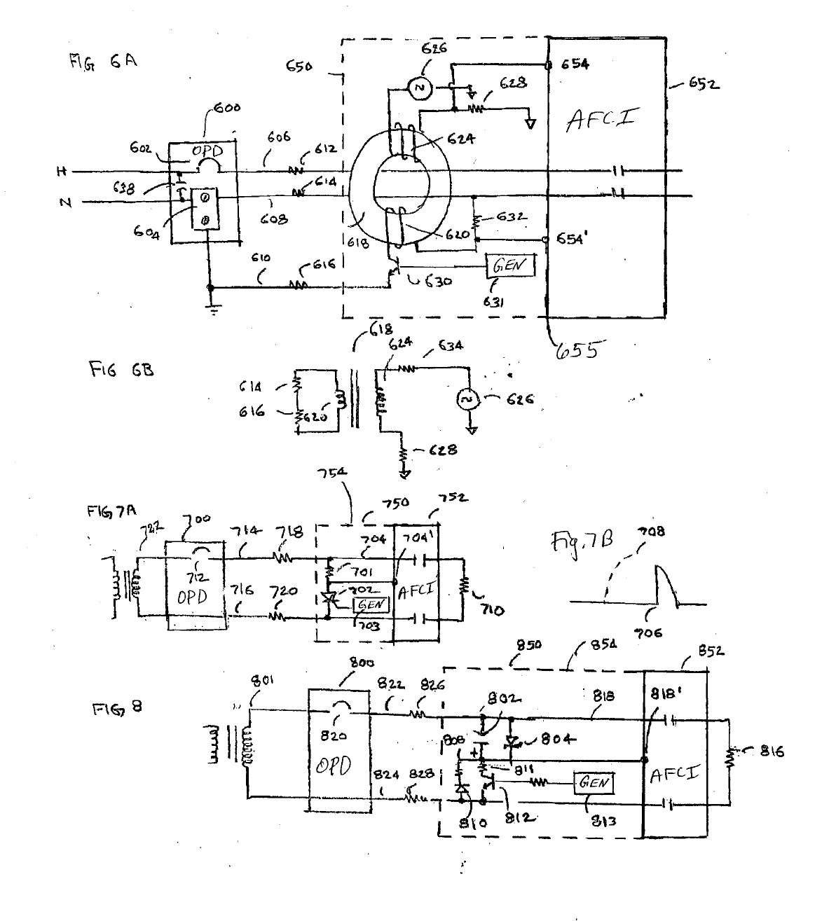

Referring now to FIG. 6A, an alternate embodiment for the ohmmeter function is shown. A panel 600 includes an overcurrent protection device (OPD) 602 which supplies a phase conductor 606 and a terminal block 604 to which a neutral conductor 608 and a ground conductor 610 are connected. The conductors have impedances 612, 614, and 616, respectively, between panel 600 and an ohmmeter 650. Ohmmeter 650 and an AFCI portion 652 make up device 655. For a 120 VAC distribution system, the worst case impedance of impedances 614 and 616 is about 0.4 Ohms. Ohmmeter 650 includes a transformer 618 having a primary winding 620 typically of two turns and a secondary winding of typically 200 turns for a turns ratio of 1:100. A transistor 630 is turned on to complete an electrical loop which includes impedances 614 and 616 and primary winding 620.

As illustrated in FIG. 6B, the impedance of 0.4 Ohms across primary winding 620 produces a reflected impedance 634 on the secondary side of transformer 618 of 0.4 Ohms multiplied by the square of the turns ratio, or 4,000 Ohms. An oscillator 626, which can be a dormant oscillator as described in FIG. 5 or a local oscillator, produces about a 10 volt, 5 kHz test signal across a voltage divider consisting of reflected impedance 634 in parallel with the impedance of secondary winding 624 and a detection resistor 628. Test signal on resistor 628 decreases as reflected impedance 634 and primary impedance 612 plus 614 increases. If the test signal on 628 is below a threshold which is above the worst case impedances of impedances 612 and 614, ohmmeter 650 produces an output signal 654 to AFCI portion 652 of device 655 which trips in the manner previously described. In an alternate embodiment, a resistor 632 is placed in series with primary winding 620. A test signal from a test generator 631 across resistor 632 is provided to an alternate signal output 654′ to AFCI portion 652.

Referring to FIG.7A, another embodiment is shown in which a transformer 722 provides power to a panel 700 containing an overcurrent protection device 712. A phase conductor 714 and a neutral conductor 716 have impedances 718 and 720 between transformer 722 and an ohmmeter 750. Ohmmeter 750 and an AFCI portion 752 make up a device 754. Panel 700 might contain a ground conductor shown as reference 610 in FIG. 6A. Panel 700 supplies power to a load 710. Ohmmeter 750 includes a resistor 701, an SCR 702, and a signal output 704.

Referring also to FIG. 7B, a waveform shows the 60 Hz phase voltage envelope 708 and SCR 702 turning on late in a half cycle at 706 in response to signal from a test generator 703, which initiates the loop impedance test. The late turn on of SCR 702 reduces the wattage demands on resistor 701. When SCR 702 turns on, resistor 701 produces a voltage step at a signal output 704 that is proportional to a resistance 718 plus a resistance 720. If the voltage step at signal output 704 is above a certain threshold, indicative that the loop resistance exceeds 0.4 Ohms, outlet type AFCI portion 752 of device 754 detects the signal and trips in the manner previously described. Alternatively, test signal can be detected across resistor 701 and test signal provided to alternate signal output 704′.

Referring to FIG. 8, a transformer 801 provides power to a panel 800 containing an overcurrent protection device (OPD) 820. A phase conductor 822 and a neutral conductor 824 have impedances 826 and 828 respectively between transformer 801 and an ohmmeter 850. Ohmmeter 850 and an AFCI portion 852 make up a device 854. Panel 800 might also contain a ground conductor shown as reference 610 in FIG. 6A. Panel 800 supplies power to a load 816. Ohmmeter 850 includes a capacitor 802 that is charged through a rectifier 810 and a resistor 808 to a voltage limited by a Zener diode 804. A test generator 813 produces a signal to turn on a transistor 812 at a particular phase angle of the power line frequency, preferably at a zero crossing. Alternatively, transistor 812 can be a current sink. Capacitor 802 is discharged through transistor 812, resistor 811, and impedances 826 and 828, producing a voltage impulse signal at a signal output 818. An impulse at output 818 above a certain threshold indicates that the loop impedance exceeds 0.4 Ohms. AFCI portion 852 of device 854 detects output signal 818 and trips in the manner previously described. Alternatively, test signal can be detected across resistor 811 and test signal provided to an alternate signal output 818′.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

What is claimed is:

1. An electrical protection device, protective of an electrical power distribution system supplying voltage from a secondary winding of a transformer through an electrically conductive path to said protection device, comprising:
a plurality of line terminals which receive voltage from said electrically conductive path; and
an impedance detector for measuring an impedance of said path;
wherein when said impedance detected by said impedance detector exceeds a pre-determined threshold, said protection device produces a signal.

2. A device according to claim 1 wherein said power distribution system further includes a load, said protection device further comprising:
a plurality of load terminals for delivering voltage from said secondary winding of said transformer to said load; and
a plurality of interrupting contacts between said load terminals and said line terminals;
wherein said signal causes said interrupting contacts to disconnect said load terminals from said line terminals.

3. A device according to claim 2 wherein said protection device is an arc fault circuit interrupter.

4. A device according to claim 2 wherein said protection device is a combination arc fault circuit interrupter and ground fault circuit interrupter.

5. A device according to claim 4 wherein said ground fault circuit interrupter portion of said protection device includes said impedance detector.

6. A device according to claim 1 further comprising an indicia, wherein a presence of said signal causes said indicia to indicate.

7. A device according to claim 1 further comprising means for disabling said signal after a predetermined interval following appearance of supply voltage at said protection device.

8. A device according to claim 1 further comprising means for disabling said signal except during each of a plurality of specified intervals.

9. A device according to claim 1 further comprising means for distinguishing said detected impedance from electrical noise.

10. A device according to claim 1, wherein when said electrical power distribution system further includes an overcurrent device in said electrically conductive path between said protection device and said secondary winding of said transformer, said protection device further comprises communication means for enabling said signal from said protection device to communicate with said overcurrent device, thereby signaling said overcurrent device to interrupt said electrically conductive path.

11. A device according to claim 1, said protective device further comprises:
a zero cross detector for locating either a first plurality of zero crosses in a current in said electrically conductive path, or a second plurality of zero crosses in said voltage; and
means for restricting said impedance measurement to at least one pre-determined interval;
wherein said at least one pre-determined interval is located proximate said first or second plurality of zero crosses.

12. A system of protective devices, comprising:
an overcurrent protection device installed at an origin of a branch circuit for interrupting current when an overcurrent condition is present;
a fault protection device installed at an outlet in said branch circuit;
wherein said fault protection device includes measuring means for measuring an impedance in at least a portion of said branch circuit and means for producing a signal when said measured impedance exceeds a predetermined value;
wherein said system of protective devices affords series fault and parallel arc fault protection to at least a portion of said electrical branch circuit.

13. A system according to claim 12 further comprising means for tripping said overcurrent protection device when said predetermined value of impedance is exceeded in said branch circuit.

14. A system according to claim 13 wherein said electrical branch circuit has a load, and said fault protection device further comprises:
a plurality of line terminals for receiving voltage from said overcurrent protection device;
a plurality of load terminals connected to said load; and
a set of interrupting contacts between said load terminals and said line terminals;
wherein said signal causes said set of interrupting contacts to disconnect said load terminals from said line terminals.

15. A system according to claim 14 wherein said fault protection device is an arc fault circuit interrupter.

16. A system according to claim 14 wherein said fault protection device is a combination arc fault circuit interrupter and ground fault circuit interrupter.

17. A system according to claim 16 wherein said ground fault circuit interrupter portion of said fault protection device includes said means for measuring said impedance.

18. A system according to claim 12 and further comprising an indicia, wherein a presence of said signal causes said indicia to indicate.

19. A system according to claim 15 wherein said portion of said electrical branch circuit receiving series fault and parallel arc fault protection from said system of protective devices includes said electrical branch circuit between said fault protection device and said overcurrent protection device.

20. A system according to claim 12 wherein said fault protection device further comprises communication means for enabling said signal from said protection device to communicate with said overcurrent device, thereby signaling said overcurrent device to interrupt said electrically conductive path.

21. A system according to claim 12 wherein said fault protection device protects said electrical branch circuit from series arc faults associated with said overcurrent protection device.

22. A system according to claim 12, wherein said measuring means also measures a supply impedance in a supply circuit, said supply circuit extending between said overcurrent protection device and a secondary winding of a transformer upstream of said overcurrent protection device, said system of protective devices affording series arc fault protection to said supply circuit.

23. An ohmmeter device incorporated in an electrical protector of an electrical power distribution system for monitoring an unknown impedance comprising:
a voltage source which induces a test current signal through said unknown impedance, thereby causing a voltage drop signal; and
a comparator which determines if said voltage drop signal across said unknown impedance exceeds a predetermined threshold, whereupon said comparator sends a signal to said electrical protector.

24. A device according to claim 23 wherein said test current signals and said voltage drop signals that are asynchronous are rejected by said ohmmeter device.

25. A device according to claim 23 and further comprising a microprocessor, wherein said microprocessor determines a waveform of said voltage source.

26. In an electrical protection device, protective of an electrical power distribution system supplying voltage from a secondary winding of a transformer through an electrically conductive path to said protection device, wherein said device includes a plurality of line terminals which receive voltage from said electrically conductive path, a plurality of load terminals for delivering voltage from said secondary winding of said transformer to a load, and a plurality of interrupting contacts between said load terminals and said line terminals;
a method for protecting said electrical power distribution system, comprising the steps of:
measuring an impedance of said path; and
producing a signal when said measured impedance exceeds a pre-determined threshold;
wherein said signal causes said interrupting contacts to disconnect said load terminals from said line terminals.

27. In an electrical protection device, protective of an electrical power distribution system supplying voltage from a secondary winding of a transformer through an electrically conductive path to said protection device, wherein said device includes a plurality of line terminals which receive voltage from said electrically conductive path, and a plurality of load terminals for delivering voltage from said secondary winding of said transformer to a load;
a method for protecting said electrical power distribution system, comprising the steps of:
generating a voltage signal to produce a test current in at least a portion of said electrical power distribution system;
measuring a signal responsive to said voltage signal; and
comparing said measured signal against a pre-determined reference signal to determine a fault condition within said portion of said electrical power distribution system.

28. A method according to claim 27, further comprising the step of disconnecting said load terminals from said line terminals when said measured signal exceeds said pre-determined reference signal.

29. A method according to claim 27, further comprising said step of indicating said fault condition when said measured signal exceeds said predetermined reference signal.
